(19) United States
(12) Patent Application Publication
(10) Pub. No.: US 2019/0188481 A1
(43) Pub. Date: Jun. 20, 2019

(54) MOTION PICTURE DISTRIBUTION SYSTEM

(71) Applicant: TOYOTA JIDOSHA KABUSHIKI KAISHA, Toyota-shi (JP)

(72) Inventors: Nobuki HAYASHI, Shinagawa-ku (JP); Takeshi BABA, Hachioji-shi (JP); Akinori SATOU, Shinagawa-ku (JP); Shinichiro ICHIKAWA, Shinagawa-ku (JP)

(73) Assignee: TOYOTA JIDOSHA KABUSHIKI KAISHA, Toyota-shi (JP)

(21) Appl. No.: 16/177,764

(22) Filed: Nov. 1, 2018

(30) Foreign Application Priority Data
Dec. 18, 2017 (JP) 2017-241708

(51) Int. Cl. G06K 9/00; G11B 27/031; G11B 27/19; G11B 27/34

(52) U.S. Cl. CPC G06K 9/00744; G11B 27/34; G11B 27/19; G11B 27/031

(57) ABSTRACT

A motion picture distribution system is provided with: an extractor configured to perform an extraction operation of extracting one or a plurality of scenes associated with a particular action of a target person from a motion picture taken by an imager; a generator configured to edit the extracted one or plurality of scenes and to generate a digest motion picture; and a distributor configured to distribute the generated digest motion picture. The extractor is configured to perform machine learning associated with the particular action, by using at least a part of a motion picture including a person as input data, in order to improve the extraction operation.

### CROSS-REFERENCE TO RELATED APPLICATIONS

This application is based upon and claims the benefit of priority of the prior Japanese Patent Application No. 2017-241708, filed on Dec. 18, 2017, the entire contents of which are incorporated herein by reference.

### BACKGROUND

### 1. Technical Field

Embodiments of the present disclosure relate to a motion picture distribution system.

### 2. Description of the Related Art

This type of system aims to reduce time and effort in editing. For example, Japanese Patent Application Laid Open No. 2006-202045 (Patent Literature 1) discloses a system in which images selected by a user from a plurality of images displayed on a screen are sorted in order that is specified by the user, to prepare an editing file. Japanese Patent Application Laid Open No. 2004-312511 (Patent Literature 2) discloses a system in which a wireless tag is added to an imaging target, in which identification information of the wireless tag included in a signal generated or issued from the wireless tag is recorded in association with a time point, and in which correspondence information between the identification information and the time point is used to cut out and edit a video associated with the imaging target from a video taken by a camera.

In a technology/technique described in the Patent Literature 1, the user needs to select the images to be included in the editing file, and the user has a relatively heavy workload, which is technically problematic. In a technology/technique described in the Patent Literature 2, the wireless tag needs to be added to the imaging target. Also, the video is cut out at the time point associated with the identification information, and the content of the cut-out video is thus unknown in editing, which is also technically problematic.

### SUMMARY

In view of the aforementioned problems, it is therefore an object of embodiments of the present disclosure to provide a motion picture distribution system in which a scene associated with a particular action or behavior is automatically extracted.

The above object of embodiments of the present disclosure can be achieved by a motion picture distribution system provided with: an extractor configured to perform an extraction operation of extracting one or a plurality of scenes associated with a particular action of a target person from a motion picture taken by an imager; a generator configured to edit the extracted one or plurality of scenes and to generate a digest motion picture; and a distributor configured to distribute the generated digest motion picture, wherein the extractor is configured to perform machine learning associated with the particular action, by using at least a part of a motion picture including a person who is the same as or different from the target person as input data, in order to improve the extraction operation.

### BRIEF DESCRIPTION OF THE DRAWINGS

FIG. 1 is a block diagram illustrating a configuration of a motion picture distribution system according to an embodiment;

FIG. 2 is a block diagram illustrating a preferable configuration of the motion picture distribution system according to the embodiment;

FIG. 3A is a conceptual diagram illustrating a concept of teacher data or teaching data;

FIG. 3B is a conceptual diagram illustrating a concept of the teacher data;

FIG. 3C is a conceptual diagram illustrating a concept of the teacher data;

FIG. 4 is a flowchart illustrating a motion picture generation/distribution process according to the embodiment;

FIG. 5A is a conceptual diagram for explaining a method of generating the teacher data with reference to tag information; and

FIG. 5B is a conceptual diagram for explaining the method of generating the teacher data with reference to the tag information.

### DETAILED DESCRIPTION OF THE EMBODIMENTS

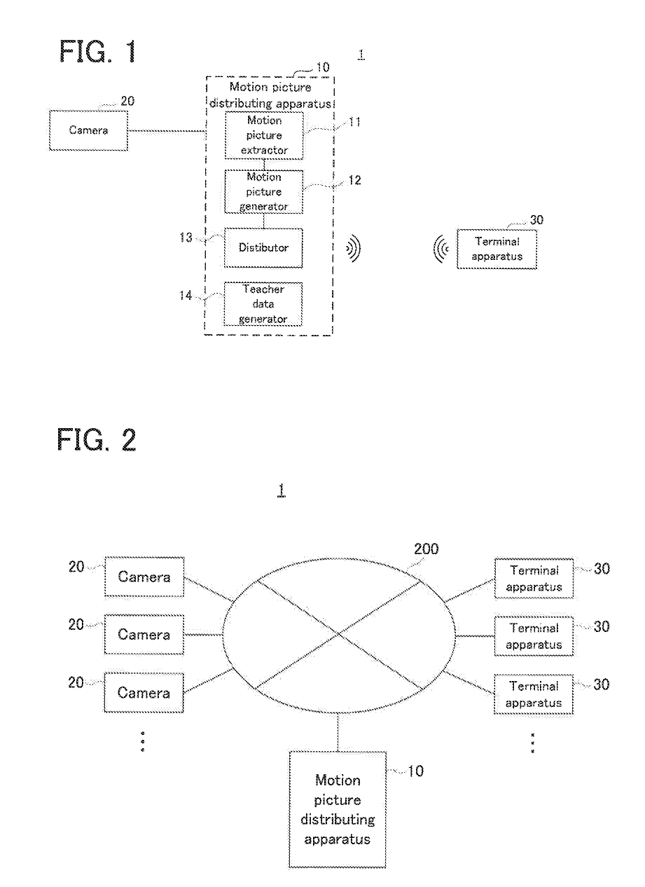

A motion picture distribution system according to an embodiment will be explained with reference to FIG. 1 to FIG. 5B.

(Configuration)

A configuration of the motion picture distribution system according to the embodiment will be explained with reference to FIG. 1 and FIG. 2. Each of FIG. 1 and FIG. 2 is a block diagram illustrating the configuration of the motion picture distribution system according to the embodiment.

In FIG. 1, a motion picture distribution system 1 is provided with a motion picture distributing apparatus 10, a camera 20, and a terminal apparatus 30. FIG. 1 illustrates only one camera 20 and one terminal apparatus 30; however, the motion picture distribution system 1 is desirably provided with a plurality of cameras 20 and a plurality of terminal apparatuses 30.

In other words, as illustrated in FIG. 2, the motion picture distribution system 1 is desirably configured in such a manner that a plurality of cameras 20, a plurality of terminal apparatuses 30, and a motion picture distributing apparatus 10 are contained in a communication network 200, such as the Internet, wherein each of the cameras 20 may be a fixed camera, a handy camera, a mobile camera, or the like and may have a communication function, each of the terminal apparatuses 30 may be a smart phone, a tablet terminal, a personal computer, or the like and may have a communication function, and the motion picture distributing apparatus 10 may include a high-functionality processing apparatus, a large capacity storage apparatus, or the like and may have a communication function. At least a part of the plurality of cameras 20 may be communicated with the motion picture distributing apparatus 10 via an exclusive communication network that is different from the communication network 200, or may be directly connected to the motion picture distributing apparatus 10 by a bilaterally communicable cable.

In FIG. 1, the motion picture distributing apparatus 10 is provided with a motion picture extractor 11, a motion picture generator 12, a distributor 13, and a teacher data generator 14, as processing blocks logically realized or processing circuits physically realized in the motion picture distributing apparatus 10. The motion picture extractor 11 may have a motion picture extraction function for extracting a scene (motion picture) including a predetermined particular action, from a motion picture taken by the camera 20, and a learning function for improving and optimizing the motion picture extraction function. The motion picture generator 12 is configured to generate a digest motion picture by editing the scene extracted by the motion picture distributing apparatus 10. The distributor 13 is configured to distribute the digest motion picture generated by the motion picture generator 12, to the terminal apparatus 30. The teacher data generator 14 will be described later.

The terminal apparatus 30 may have the communication function for communicating with the motion picture distributing apparatus 10, a reproduction function for reproducing a motion picture, and a display function for displaying the reproduced motion picture. Various existing aspects can be applied to the camera 20, and an explanation of the camera 20 will be thus omitted.

(Machine Learning Process)

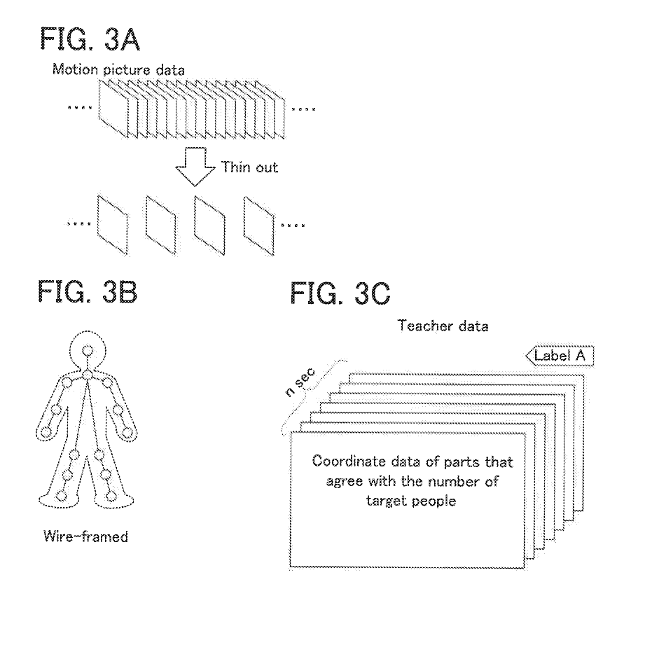

A machine learning process performed by the learning function of the motion picture extractor 11 will be explained with reference to FIG. 3A to FIG. 3C. Each of FIG. 3A to FIG. 3C is a conceptual diagram illustrating a concept of teacher data or teaching data.

Firstly, the teacher data used for machine learning will be explained. If motion picture data taken for the teacher data (i.e., motion picture data including a particular action to be machine-learned) is used as it is, a data amount becomes relatively large. Thus, a frame rate of the motion picture data is reduced; namely, frame images are thinned out (refer to FIG. 3A). If the frame rate of the original motion picture data is, for example, 30 fps (frames per second), it is reduced to, for example, 5 fps or the like. How much to reduce the frame rate may be determined by whether or not the particular action extracted by the motion picture extractor 11 can be recognized, or whether or not the particular action can be distinguished from another action, or the like, by using the motion picture whose frame rate is reduced. From a viewpoint of a processing load, it is desirable that the frame rate is ideally reduced to a necessary and sufficient level; however, a rather high frame rate may be firstly set with a margin, and the frame rate may be then appropriately reduced in a manner that reflects a result of the subsequent machine learning.

Then, for each of the frame images that constitute the motion picture data whose frame rate is reduced, a person included in the frame image (i.e., a person who performs the particular action) is wire-framed (refer to FIG. 3B). Various existing aspects can be applied to a technology/technique associated with the wire-framing, and an explanation of the wire-framing will be thus omitted.

White circles in FIG. 3B illustrate parts of a body that draw attention in wire-framing. There are an arbitrary number of parts of the body that draw attention; however, the number may be set to a number that allows the particular action extracted by the motion picture extractor 11 to be distinguished from another action. For example, the number may be set in accordance with a target particular action, such as 18 parts and 5 parts. The wire-framed person (i.e., an image expressed by lines and white circles as illustrated in FIG. 3B) will be referred to as a “wireframe”, as occasion demands. The parts of the body that draw attention (the white circles in FIG. 3B) will be referred to as “points” as occasion demands.

If the frame image includes a plurality of people, the number of people to be wire-framed may vary depending on the aforementioned particular action. For example, if the particular action is passing through a predetermined section, the number of people to be wire-framed may be, for example, “1”. For example, if the particular action is greeting another person, the number of people to be wire-framed may be, for example, “2”.

Then, coordinate data of the plurality of points included in the wireframe for frame images of a temporally continuous first predetermined time (e.g., 3 seconds) are grouped with label data indicating the particular action (i.e., positive example data), thereby to generate the teacher data.

It can be said that the “coordinate data of the plurality of points included in the wireframe for the frame images of the temporally continuous first predetermined time” is data indicating coordinate transition of the wireframe. In other words, it can be said that the teacher data is data indicating the coordinate transition of the wireframe corresponding to the particular action. The “first predetermined time” is desirably a lower limit value of a time length in which the particular action can be recognized by the machine learning. This is because as the “first predetermined time” increases, the teacher data increases, which may increase the processing load. From the viewpoint of the processing load, it is desirable that the first predetermined time is ideally reduced to a necessary and sufficient level; however, a rather long time length may be firstly set with a margin, and the first predetermined time may be then appropriately reduced in a manner that reflects a result of the subsequent machine learning.

The motion picture extractor 11 is configured to optimize a parameter associated with the extraction of the scene including the particular action (i.e., a parameter included in an algorithm used to extract the scene), by supervised machine learning, which uses the teacher data generated in the above manner. At this time, the motion picture extractor 11 is configured to determine an action pattern corresponding to one particular action to be learned (e.g., characteristic coordinate transition indicating one particular action), on the basis of the coordinate transition of the plurality of points included in the teacher data (i.e., the coordinate transition of the wireframe). The motion picture extractor 11 is configured to optimize the action pattern (i.e., to optimize the parameter) in such a manner that, for all a plurality of teacher data associated with the one particular action, the coordinate transition of the wireframe indicated by each of the plurality of teacher data is determined to correspond to the one particular action. In this manner, the motion picture extractor 11 is configured to use the machine learning that uses the coordinate transition of the wireframe corresponding to the particular action that is desirably digested as the teacher data, thereby extracting the scene in which the coordinate transition of the wireframe associated with an identified individual overlaps the coordinate transition of the wireframe corresponding to the particular action. In other words, the motion picture extractor 11 is configured to extract the scene in which a correlation height exceeds a predetermined threshold value (i.e., a threshold value for determining agreement/disagreement of the action) between multidimensional data that constitute the wireframe associated with the teacher data (e.g., several tens to several thousands-dimensional data) and multidimensional data that constitute the wireframe associated with the identified individual, from image data taken by the camera. An extraction result may be shown with time or imaging time of the image data associated with the extracted scene, or the like.

The particular action may not be limited to one type, but may have a plurality of types. If there are a plurality of types of particular actions, the teacher data may be generated with the label data for each particular action added thereto. In other words, if there are an action A, an action B, an action C, and so on as the particular action, the teacher data is generated with a label A, a label B, a label C, and so on added thereto as the label data.

(Motion Picture Generation/Distribution Process)

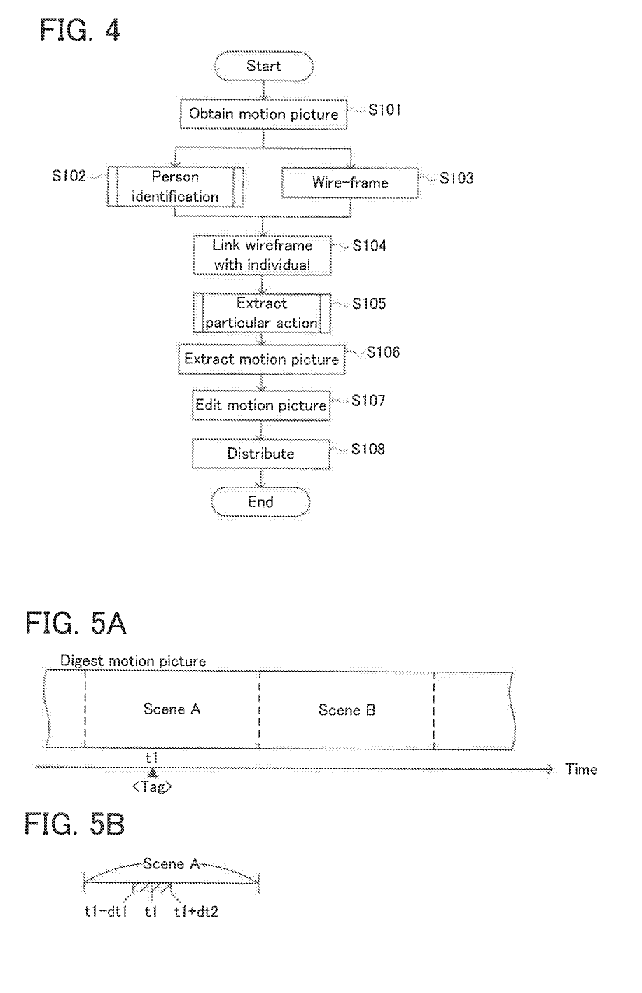

A motion picture generation/distribution process performed by the motion picture distributing apparatus 10 will be explained with reference to a flowchart in FIG. 4.

In FIG. 4, firstly, the motion picture extractor 11 obtains the motion picture data taken by the camera 20 (step S101). The motion picture extractor 11 performs a personal identification process on the obtained motion picture data (step S102). Specifically, the motion picture extractor 11 may have identification information (e.g., names, ID numbers, etc.) of those who are imaging targets of the camera 20, and face images linked to the identification information, in advance. The motion picture extractor 11 may perform a facial authentication process based on the face images, and may identify a person from the identification information linked to a matched face image.

As a result of the step S102, for example, the identification information indicating the identified person, time (e.g., time stamps) associated with frame images including the identified person, and central coordinates of a face area of the identified person in the frame images may be outputted.

In parallel with the step S102, the motion picture extractor 11 wire-frames a person included in the obtained motion picture data (step S103). Specifically, the motion picture extractor 11 may reduce the frame rate of the motion picture data in order to reduce the processing load. The motion picture extractor 11 may wire-frame a person included in each of the frame images that constitute the motion picture data whose frame rate is reduced.

As a result of the step S103, for example, the wireframe including the coordinate data of the plurality of points (refer to the white circles in FIG. 3B), and time (e.g., time stamps) associated with the frame images may be outputted. In other words, as a result of the step S103, a bundle of wireframes (i.e., data indicating the coordinate transition of the wireframe), such as a wireframe of a time point tᵢ, a wireframe of a time point tᵢ₊₁, a wireframe of a time point tᵢ₊₂, and so on, may be outputted.

The motion picture extractor 11 then links the wireframe to the identification information, on the basis of the result of the step S102 and the result of the step S103, thereby identifying the wire-framed person (step S104). Specifically, the motion picture extractor 11 may select the result of the step S102 and the result of the step S103 that correspond to each other, with reference to the time associated with the frame images. The motion picture extractor 11 may then compare the central coordinates of the face area, for example, with coordinates of at least one of a nose and a neck, out of the coordinate data of the plurality of points included in the wireframe (e.g., may determine whether or not a difference between the central coordinates of the face area and the coordinates of at least one of the nose and the neck is less than or equal to a predetermined value), thereby linking the wireframe to the identification information.

The motion picture extractor 11 then extracts the particular action by using the algorithm in which the parameter is optimized by the aforementioned machine learning process (step S105). The step S105 will be conceptually explained. If the coordinate transition of the wireframe (i.e., the coordinate transition of the plurality of points included in the wireframe) overlaps the action pattern corresponding to the particular action learned by the aforementioned machine learning process (e.g., the characteristic coordinate transition indicating the particular action), it is determined to be the particular action, and if not, it is determined not to be the particular action. The motion picture extractor 11 may extract the particular action by detecting the coordinate transition of the wireframe that overlaps the action pattern from the data indicating the coordinate transition of the wireframe outputted in the step S103.

As a result of the step S105, for example, the identification information linked to the wireframe corresponding to the particular action, and the time associated with the frame images related to the wireframe corresponding to the particular action may be outputted. In other words, a time at which the particular action is performed and a person who performs the particular action may be specified in the step S105.

The motion picture extractor 11 may then extract the scene including the particular action, from the motion picture data obtained in the step S101 (i.e., from the motion picture data whose frame rate is not reduced), on the basis of the frame images included in the result of the step S105 (step S106). The identification information included in the result of the step S105 may be added to the extracted scene. If there are a plurality of scenes including the particular action, the plurality of scenes may be extracted.

Each of the extracted scenes may include a period obtained from the time associated with the frame images related to the wireframe corresponding to the particular action, and a length of each extracted scene may be a second predetermined time (e.g., 20 seconds), which is longer than the above period. Here, the “second predetermined time” may be set as a recognizable time length in which a user can recognize the implementation of the particular action when the user watches the extracted scene, or as a time length that is longer by a predetermined time than the recognizable time length.

The motion picture generator 12 then edits the one or plurality of scenes extracted in the step S106 (step S107). Specifically, the motion picture generator 12 may classify the one or plurality of scenes extracted in the step S106, for example, for each person, on the basis of the identification information added to the scenes. The motion picture generator 12 may then wire-frame the person included in the classified scenes.

The motion picture generator 12 may then determine, for example, whether or not there is a period in which the wire-framed person has a relatively small movement, or whether or not there is a period in which the wire-framed person repeats the same action, or the like, on the basis of the transition of the respective coordinate data of the plurality of points included in the wireframe. This is because the length of each of the scenes extracted in the step S106 is longer than the period associated with the plurality of frame images extracted in the step S105, and because the particular action is not always included in a whole period of each extracted scene. If there is a period in which the particular action is not included in the extracted scene, the user who watches the digest motion picture possibly feels that the scene is redundant.

For example, if it is determined that there is the period in which the wire-framed person has the relatively small movement, or if it is determined that there is the period in which the wire-framed person repeats the same action, or the like, then, the motion picture generator 12 may remove (i.e., cut) the frame images corresponding to the period in which the wire-framed person has the relatively small movement, or the frame images corresponding to the period in which the wire-framed person repeats the same action, or the like, from the extracted scenes.

The motion picture generator 12 may then, for example, arrange the scenes classified for each person, for example, in time series, thereby generating the digest motion picture, which is an edited motion picture. The generated digest motion picture may be stored in the motion picture distributing apparatus 10.

The distributor 13 then distributes the digest motion picture to the terminal apparatus 30 (step S108). The existing various aspects can be applied to a method of distributing the digest motion picture, but an example is streaming distribution. If the distributor 13 receives access from the terminal apparatus 30, the distributor 13 may transmit information associated with the digest motion picture stored in the motion picture distributing apparatus 10 (e.g., a list indicating the digest motion picture that can be distributed, etc.) to the terminal apparatus 30. If the digest motion picture desired by the user of the terminal apparatus 30 is specified via the terminal apparatus 30, the distributor 13 may perform the streaming distribution of the specified digest motion picture to the terminal apparatus 30.

(Teacher Data Generation Process)

The user of the terminal apparatus 30 can add an arbitrary tag to the distributed digest motion picture. If the user tags the digest motion picture, tag information associated with an added tag may be transmitted from the terminal apparatus 30 to the motion picture distributing apparatus 10. The teacher data generator 14 of the motion picture distributing apparatus 10 is configured to generate new teacher data that can be used for the aforementioned machine learning, on the basis of the tag information.

As illustrated in FIG. 5A, a specific explanation will be given to an example in which the tag is added at a time point t1 of the digest motion picture. The teacher data generator 14 may extract motion picture data in a predetermined range including the time point t1 (which is a range between a time point t1−dt1 and a time point t1+dt2 in FIG. 5B), from a scene A included in the digest motion picture, on the basis of the tag information.

The teacher data generator 14 may then reduce the frame rate of the extracted motion picture data (refer to FIG. 3A). Then, for each of the frame images that constitute the motion picture data whose frame rate is reduced, the teacher data generator 14 may wire-frame a person included in the frame image. The teacher data generator 14 may then group the coordinate data of the plurality of points included in the frame images, thereby to generate new teacher data. The motion picture extractor 11 may perform the machine learning using the generated new teacher data if the new teacher data is generated.

The content of the scene A in the digest motion picture is recorded, for example, in a log of the motion picture generator 12, and the teacher data generator 14 may thus add the label data to the new teacher data with reference to the log. Information associated with a user who adds the tag may be added to the new teacher data.

Here, the tag may be added to an operation of particular interest to the user of the terminal apparatus 30 (and the motion picture distribution system 1), i.e., a part of operations that constitute the particular action in many cases. The new teacher data is generated on the basis of the tag information and the machine learning is performed by using the generated teacher data, by which, for example, the user's sensitivity or the like can be reflected in the algorithm used to extract the scene. Thus, as the new teacher data based on the tag information is stored more (e.g., as the user more frequently uses the motion picture distribution system 1), the digest motion picture that is more appropriate to the user may be generated and distributed.

### Technical Effect

In the motion picture distribution system 1, the scene(s) including the particular action may be automatically extracted by the motion picture extractor 11. In addition, the scene(s) including the particular action may be automatically edited by the motion picture generator 12 to generate the digest motion picture. Thus, for example, the user does not need to confirm the scene(s) including the particular action while reproducing the motion picture and extract and edit the scene(s).

In the motion picture distribution system 1, the new teacher data is subsequently generated on the basis of the tag information, and the machine learning using the generated teacher data is repeated. It is thus possible to improve accuracy associated with the extraction of the scene(s) by the motion picture extractor 11. Moreover, the tag is added to the operation of particular interest to the user in many cases. It is thus possible to generate the digest motion picture that is more appropriate to the user, by repeating the machine learning using the teacher data.

The teacher data used for the machine learning associated with the motion picture distribution system 1 is configured to be the data indicating the transition of the respective coordinate data of the plurality of points included in the wireframe. Such a configuration allows the motion picture extractor 11 to machine-learn the particular action, relatively easily.

### Modified Examples

(1) In the step S102 of the motion picture generation/distribution process illustrated in FIG. 4, a facial expression recognition process may be performed in addition to the facial authentication process. In this case, as a result of the step S102, for example, the identification information indicating the identified person, facial expression information associated with a facial expression of the identified person, the time associated with the frame images including the identified person, and the central coordinates of the face area of the identified person in the frame images may be outputted. Then, in the step S104, the wireframe, the identification information, and the facial expression information are linked to one another. Such a configuration makes it possible to generate the digest motion picture in which one person performs the particular action with a particular facial expression.
(2) In the step S107 of the motion picture generation/distribution process illustrated in FIG. 4, the extracted scenes may be classified not only for each person, but also in accordance with a time zone, where to belong (wherein the identification information needs to include information indicating where to belong), or the like. Such a configuration makes it possible to generate the digest motion picture of the person who performs the particular action, for example, for each time zone or each belonging.

### Specific Application Examples

(1) An explanation will be given to, for example, a case where the motion picture distribution system 1 is used to record actions or behavior of nursery school children at a nursery school. In this case, the particular action may include (i) arriving at the nursery school (e.g., a child and a guardian approach a nursery teacher, and the guardian leaves the nursery teacher, etc.), (ii) playing (e.g., children run together, etc.), (iii) providing lunch (e.g., the child brings the hand closer to the mouth for meals and then puts the hand down, etc.), (iv) napping (e.g., lying down on a bed, etc.), (v) going home from the nursery school (e.g., the guardian approaches the child, and the guardian and the child walk together, etc.), and the like.

A plurality of cameras 20 may be provided in places in which the particular action supposedly occurs, such as, for example, near a gate of the nursery school (i.e., an arrival/leaving place), inside a nursery school building, and in a playground of the nursery school. The motion picture extractor 11 of the motion picture distributing apparatus 10 may extract the scenes including the particular action from the motion picture data imaged by each of the plurality of cameras 20. The motion picture generator 12 may edit the extracted scenes for each child and may generate the digest motion picture for the each child.

If the digest motion picture of a child is distributed to the terminal apparatus 30 owned by the guardian of the child, the guardian can confirm a state of the child that cannot be known from a message notebook of the nursery school. Moreover, if the digest motion picture of a child is distributed to the terminal apparatus 30 owned by the nursery teacher, the digest motion picture can be used to support childcare planning for each child.

(2) An explanation will be given to, for example, a case where the motion picture distribution system 1 is used to record actions or behavior at night at a nursing facility. In this case, the particular action may include (i) going in and out of each room at night, (ii) sleeping (e.g., lying down on a bed, etc.), (iii) getting up (e.g., getting out of bed, etc.), and the like.

The camera 20 may be provided in each room. The motion picture extractor 11 of the motion picture distributing apparatus 10 may extract the scenes including the particular action from the motion picture data imaged by each of a plurality of cameras 20. The motion picture generator 12 may edit the extracted scenes for each person admitted to the nursing facility and may generate the digest motion picture for the each person.

If the digest motion picture of a person admitted to the nursing facility is distributed to the terminal apparatus 30 owned by an employee of the nursing facility, for example, the employee can understand the actions of the person at night. Moreover, if the digest motion picture of a person admitted to the nursing facility is distributed to the terminal apparatus 30 owned by relatives of the person, for example, the relatives can know a state of the person at night.

(3) In another example, for example, if the camera 20 may be provided at a factory and if abnormal behavior of a worker is set as the particular action, the digest motion picture associated with the abnormal behavior of the worker can be generated and distributed by the motion picture distribution system 1. Alternatively, for example, if the camera 20 is provided at an airport and if abnormal behavior of a passenger or the like is set as the particular action, the digest motion picture associated with the abnormal behavior of the passenger or the like can be generated and distributed by the motion picture distribution system 1.

The camera 20 may not be fixed in a predetermined place, and may be, for example, portable. Specifically, the camera 20 may be a portable home video camera. In addition, as described in the aforementioned modified example (1), if the motion picture extractor 11 is configured to perform the facial authentication process and the facial expression recognition process in the step S102 of the motion picture generation/distribution process illustrated in FIG. 4, for example, it is possible to generate and distribute the digest motion picture including the scenes in which the particular action is performed with a smile, from the motion picture data taken by the aforementioned video camera.

Various aspects of embodiments of the present disclosure derived from the embodiment and the modified examples explained above will be explained hereinafter.

A motion picture distribution system according to an aspect of embodiments of the present disclosure is provided with: an extractor configured to perform an extraction operation of extracting one or a plurality of scenes associated with a particular action of a target person from a motion picture taken by an imager; a generator configured to edit the extracted one or plurality of scenes and to generate a digest motion picture; and a distributor configured to distribute the generated digest motion picture, wherein the extractor is configured to perform machine learning associated with the particular action, by using at least a part of a motion picture including a person who is the same as or different from the target person as input data, in order to improve the extraction operation. In the aforementioned embodiment, the “motion picture extractor 11” corresponds to an example of the extractor, the “motion picture generator 12” corresponds to an example of the generator, and the “distributor 13” corresponds to an example of the distributor.

On the extractor of the motion picture distribution system, the machine learning associated with the particular action is performed. As a result of the machine learning, the extractor can appropriately recognize the scenes associated with the particular action. The machine learning may use at least the part of the motion picture including the person as the input data, but the “person” may be an unidentified person; namely, the “person” may be not necessarily the same as the “target person”.

In the motion picture distribution system, the scenes associated with the particular action of the target person may be automatically extracted by the extractor. The generator may then edit the extracted scenes and generate the digest motion picture. Therefore, according to the motion picture distribution system, it is possible to automatically extract the scenes associated with the particular action of the target person and to generate the digest motion picture.

In an aspect of the motion picture distribution system, the motion picture distribution system is provided with an acquirer configured to obtain a tagged digest motion picture on condition that the distributed digest motion picture is tagged, and the extractor is configured to perform the machine learning by using at least a part of the tagged digest motion picture as the input data, in addition to at least the part of the motion picture including the person. In the aforementioned embodiment, the “teacher data generator 14” corresponds to an example of the acquirer.

In this aspect, at least the part of the tagged digest motion picture may be used as the input data of the machine learning. In other words, in this aspect, even when the motion picture distribution system operates for the purpose of a predetermined service, the machine learning that uses at least the part of the tagged digest motion picture as the input data may be repeated. It is thus possible to improve the accuracy of extracting the scenes associated with the particular action, as the tagged digest motion picture increases.

A motion picture editing apparatus according to another aspect of embodiments of the present disclosure is provided with: an imager configured to image a person and configured to output image data; a facial recognizing device configured to recognize a face area of the person on the outputted image data; a wire-framing device configured to wire-frame the person on the outputted image data; an personal identifying device configured to obtain face center coordinates associated with the recognized face area, configured to obtain neck coordinates associated with the wire-framed person, and configured to identify an individual associated with the person on the basis of a distance between the obtained face center coordinates and the obtained neck coordinates; and a digest image preparing device configured to use machine learning that uses coordinate transition of a wireframe corresponding to a particular action that is desirably digested as teacher data, thereby extracting a scene in which coordinate transition of a wireframe associated with the identified individual overlaps the coordinate transition of the wireframe corresponding to the particular action from the outputted image data, and configured to prepare a digest image associated with the identified individual on the basis of the extracted scene.

In the aforementioned embodiment, the “camera 20” corresponds to an example of the imager, the “motion picture extractor 11” corresponds to an example of the facial recognizing device, the wire-framing device, and the personal identifying device, and the “motion picture extractor 11” and the “motion picture generator 12” correspond to an example of the digest image preparing device.

According to the motion picture editing apparatus, the “imager” may have: a camera function of taking a motion picture or a video, which is used as a base of the digest image; and a camera function of taking not only the motion picture but also still images or pictures and of performing facial recognition. The imager may include one or a plurality of cameras.

In operation thereof, while a person or a plurality of people are imaged, the face area of the person or people on the image data may be recognized by the facial recognizing device. Here, for example, personal identification based on facial recognition (i.e. facial authentication) may be performed. At this time, facial expression recognition may be performed in addition to the facial recognition. In parallel with this, or before or after this, the person on the image data may be wire-framed by the wire-framing device. Then, the individual associated with the person may be identified by the personal identifying device on the basis of the distance between the face center coordinates associated with the recognized face area and the neck coordinates associated with the wire-framed person. In other words, a result of the facial authentication and the wireframe may be linked to each other as data. This may make it clear who performs what type of movement.

Then, on the digest image preparing device, by the machine learning that uses the coordinate transition of the wireframe corresponding to the particular action that is desirably digested as the teacher data, the scene in which the coordinate transition of the wireframe associated with the identified individual overlaps the coordinate transition of the wireframe corresponding to the particular action may be extracted from the outputted image data.

Here, the “overlap” may conceptually mean to have high correlation, to have close relation, to agree with, or to match, to an extent that is appropriate to treat it as matching each other or corresponding to each other. In other words, the “overlap” may conceptually include not only exact match but also matching to some extent, which is namely when the particular action that is the same or that belongs to the same category is regarded as being performed. Moreover, the “scene” may mean a motion picture part taken in a time zone in which a specified person or the identified individual performs the particular action out of the taken motion picture (or image data).

Then, the digest image of the identified individual may be prepared on the basis of the extracted scene by the digest image preparing device.

As described above, it is possible to relatively easily prepare the digest image of the identified individual or the specified person, on the basis of the scene in which the coordinate transition of the wireframe associated with the identified individual identified by the facial recognition overlaps the coordinate transition of the wireframe based on the machine learning.

A motion picture editing apparatus according to another aspect of embodiments of the present disclosure is provided with: a teacher data preparing device configured to wire-frame a person on image data in which the person is imaged and configured to prepare teacher data indicating coordinate transition of a wireframe associated with a particular action of the person of a predetermined time; an imager configured to image a target person who is the same as or different from the person and configured to output image data; a wire-framing device configured to wire-frame the target person on the outputted image data; and a digest image preparing device configured to use machine learning that uses the prepared teacher data and configured to extract the coordinate transition of the wireframe corresponding to the particular action from coordinate transition of a wireframe associated with the target person, thereby preparing a digest image associated with the particular action of the target person.

In the aforementioned embodiment, the “teacher data generator 14” corresponds to an example of the teacher data preparing device, the “camera 20” corresponds to an example of the imager, the “motion picture extractor 11” corresponds to an example of the “wire-framing device”, and the “motion picture extractor 11” and the “motion picture generator 12” correspond to an example of the digest image preparing device.

The “person” is an unspecified person. The “person” and the “target person” may be the same or different. The “predetermined time” may be set before the preparation of the teacher data, as a time length that is desirable in determining an action pattern by the matching learning using the teacher data. The predetermined time as described above may be set in advance by experiments, experiences, simulations, or arithmetic operations, as a value that is sufficient to prepare the teacher data of the particular action, for example, on the basis of an operation speed and an operation time of a human being, or on the basis of an operation speed and an operation time in performing the particular action whose digest motion picture is desired to be eventually prepared. Moreover, an appropriate initial value may be given to the predetermined time, and the predetermined time may be changed, as occasion demands, in the subsequent process of preparing the teacher data.

The teacher data preparing device is configured to prepare the teacher data from the coordinate transition of the wireframe within the predetermined time, such as, for example, 3 seconds, or the like. An identification number and an identification name may be automatically allocated or manually given to the teacher data when the teacher data is prepared.

The digest image preparing device is configured to use the machine learning using the teacher data, thereby determining the action pattern to be extracted as the particular action that is desired to be digested. The digest image preparing device is configured to prepare the digest motion picture associated with the particular action of the target person by extracting the coordinate transition of the wireframe corresponding to the action pattern from the coordinate transition of the wireframe associated with the wire-framed target person.

As described above, the adoption of the machine learning using the teacher data, which is unique to the present application, allows easy learning of the particular action that is desirably digested, and allows relatively easy preparation of the digest image of the particular action associated with the target person.

<Computer Program Product>

A computer program product according to another aspect of embodiments of the present disclosure is configured to make a computer function as the aforementioned motion picture editing apparatus (including various aspects thereof).

According to the computer program product, the aforementioned motion picture editing apparatus in the embodiment described above (including various aspects thereof) can be relatively easily realized, as the computer reads and executes the computer program product into a computer system from a recording medium for storing the computer program, such as a ROM, a CD-ROM, a DVD-ROM, and a hard disk, or from a solid type storage that can be attached to/detached from the computer system, such as a universal serial bus (USB) memory, or as it executes the computer program product after downloading the computer program into the computer system through a communication device.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A motion picture distribution system comprising:
an extractor configured to perform an extraction operation of extracting one or a plurality of scenes associated with a particular action of a target person from a motion picture taken by an imager;
a generator configured to edit the extracted one or plurality of scenes and to generate a digest motion picture; and
a distributor configured to distribute the generated digest motion picture, wherein
said extractor is configured to perform machine learning associated with the particular action, by using at least a part of a motion picture including a person who is the same as or different from the target person as input data, in order to improve the extraction operation.

2. The motion picture distribution system according to claim 1, wherein
said motion picture distribution system comprises an acquirer configured to obtain a tagged digest motion picture on condition that the distributed digest motion picture is tagged, and
said extractor is configured to perform the machine learning by using at least a part of the tagged digest motion picture as the input data, in addition to at least the part of the motion picture including the person.
